(19) United States
(12) Patent Application Publication
(10) Pub. No.: US 2008/0217957 A1
(43) Pub. Date: Sep. 11, 2008

(54) AERODYNAMIC FOREBODY SHAPE FOR VAN TRAILER

(75) Inventors: Ronald E. Schoon, Fort Wayne, IN (US); Ronald J. Elwart, Wichita, KS (US); Fong-Loon Pan, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(73) Assignee: International Truck Intellectual Property Company, LLC, Warrenville, IL (US)

(21) Appl. No.: 12/033,062

(22) Filed: Feb. 19, 2008

Related U.S. Application Data
(60) Provisional application No. 60/893,012, filed on Mar. 5, 2007.

(51) Int. Cl. B62D 35/00

(52) U.S. Cl. 296/180.4

(57) ABSTRACT

An aerodynamic forebody device is provided for use with a tractor-trailer combination vehicle to be installed on the front of the semi-trailer. By optimizing the inclination angle of the top surface of the aerodynamic forebody device, aerodynamic drag is minimized. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### FIELD OF THE INVENTION

This invention relates to an aerodynamic forebody device for use with a tractor-trailer combination vehicle. The invention improves the fuel economy of a tractor-trailer combination vehicle by reducing aerodynamic drag. Specifically, this invention reduces the aerodynamic drag caused by the air gap between the tractor and the trailer of the tractor-trailer combination vehicle.

### BACKGROUND

Today, the most aerodynamically efficient tractor-trailer combination vehicles have air fairings either mounted on the tractor cab roof or formed as an integral part of the cab of the tractor. Tractors having an air fairing formed as an integral part of the cab are said to be equipped with a “Skyrise” cab. Tractors having an air fairing mounted on the tractor cab roof or integrated into the tractor cab are also typically provided with side extenders, which are attached to the rearward vertical corners of the cab. These devices partially close the tractor-trailer gap and are intended to guide the air smoothly across the gap and onto the trailer top and sides. It is also common today for tractor-trailers to operate with as small of gap as practical between the tractor and trailer.

Despite the cab roof-mounted or integrated air fairings and cab-mounted side extenders which are in production today, there is still a significant amount of air that flows through the tractor-trailer gap when the tractor-trailer combination vehicle is in operation on the road. This is the case whether or not there is a component of yaw or side-wind present, or even when the amount of side-wind is modest. Also, the gap required between the vehicle tractor and the trailer cannot readily be made smaller than that which is required for low speed maneuvering. This means that the required gap is a significant contributor to aerodynamic inefficiency.

### SUMMARY OF THE INVENTION

One embodiment of the aerodynamic forebody device for a van trailer or semi-trailer works in conjunction with a tractor having a cab having an aerodynamic roof-mounted air fairing or integrated air fairing, cab-mounted side extenders, and a relatively close tractor-trailer gap to further reduce aerodynamic drag. This embodiment of the aerodynamic forebody device for a van trailer or semi-trailer is attached to the front of the van trailer or semi-trailer, where it helps airflow attach smoothly to the front, top, and sides of the van trailer or semi-trailer. It is also shaped such that it manipulates the air flowing through the tractor-trailer gap in order to locally accelerate that airflow, particularly during conditions wherein a side wind component is present, thereby lowering the static pressure on the front face of the van trailer or semi-trailer.

The aerodynamic forebody device is in the form of a rectangular parallelepiped, except that the top face may be inclined slightly downward, and the forward vertical edges may be rounded. In at least one embodiment, when viewed from the top, both of the rounded forward vertical edges have a cross-section that describes a quarter-ellipse. In another such embodiment, the long axes of the cross-section of the quarter-ellipse forward vertical edges are oriented in the longitudinal direction relative to the axis of the vehicle. The quarter-ellipse cross-section of the forward vertical edges may represent the optimum shape for attaching the airflow to the side of the trailer or semi-trailer. Preferably, at least a portion of the front face of the aerodynamic forebody device may be flat or nearly flat, such that the rounded or quarter-ellipse forward vertical edges are separated, and do not form a completely convex surface. Alternately, the front face of the aerodynamic forebody device may be entirely convex, such that the quarter-ellipse vertical edges intersect a segment of a cylinder or a segment of a shallow ellipse at a tangent. The rounded or quarter-ellipse forward vertical edges are of sufficient radii to allow the van trailer or semi-trailer and aerodynamic forebody device to clear the tractor cab during articulation.

As noted previously, the top face of the aerodynamic forebody device may be inclined slightly downward. That is to say, the forward top horizontal edge of the rectangular parallelepiped may be lower than the rearward top horizontal edge that abuts the forward top horizontal edge of the van trailer or semi-trailer. The inclination angle between the top face of the aerodynamic forebody device and horizontal greatly affects the resultant reduction in aerodynamic drag. In one embodiment of the aerodynamic forebody device, the inclination angle “A” of the top face is between 5 and 30 degrees from horizontal. In a preferable embodiment, the inclination angle “A” of the top face is between 15 and 22 degrees from horizontal. In an even more preferable embodiment, the inclination angle “A” of the top face is between 15 and 22 degrees from horizontal and the quarter-ellipse forward vertical edges of the rectangular parallelepiped aerodynamic forebody device are separated by a flat or nearly flat front face. In an even more preferable embodiment, the inclination angle of the top face is between 15 and 22 degrees from horizontal and the forward vertical edges of the rectangular parallelepiped aerodynamic forebody device are quarter-ellipse in cross-section, separated by a flat or nearly flat front face, and are such that the long axes of the quarter-ellipsis are oriented in the longitudinal direction relative to the axis of the vehicle. Also, the top face of the aerodynamic forebody device may be entirely planar, or it may be slightly convex or concave.

The rectangular parallelepiped shape of the aerodynamic forebody device extends from the top to the bottom of the front of the van trailer or semi-trailer, and from side to side, such that it completely covers the front surface of the van trailer or semi-trailer. In this way, the effect of lowering the static pressure on the front face of the van trailer or semi-trailer is maximized over the entire front face, rather than just a portion thereof. By extending from the top to the bottom of the front of the van trailer or semi-trailer, the rounded or quarter-ellipse forward vertical edges also maximize the net effect of smoothly attaching airflow to the sides of the van trailer or semi-trailer.

While the aerodynamic forebody device accelerates air flow through the gap between the cab of the tractor and the van trailer or semi-trailer by narrowing the gap, it does so without significantly shifting the weight of the van trailer or semi-trailer forward, or in the case of a semi-trailer without moving the kingpin connection forward. The aerodynamic forebody device may be made from aluminum, fiberglass, molded polymer, reinforced molded polymer, carbon fiber matrix, or any other lightweight and relatively strong material. It may be provided with a support and reinforcing frame made from steel, aluminum, or other structural material, or it may be unitary in design. It may be provided with reinforcing ribs or other egg-crate type structure on the inside face.

The aerodynamic forebody device may be attached to the front of the van trailer or semi-trailer by various means. One embodiment uses conventional fasteners to attach the aerodynamic forebody device to threaded bosses or holes provided upon the van trailer or semi-trailer. Another embodiment uses clamps to attach the aerodynamic forebody device to the van trailer or semi-trailer. At least one embodiment uses a picture-hanger type bracket either upon the aerodynamic forebody device or upon the van trailer or semi-trailer, or mating brackets upon both the aerodynamic forebody device and the van trailer or semi-trailer, in conjunction with conventional clamps or conventional fasteners and bosses, such that the aerodynamic forebody device may be hung upon the picture-hanger bracket or mating brackets prior to securing the remaining clamps or conventional fasteners. The aerodynamic forebody device may be provided with forklift pockets or one or more lifting eyes, and corresponding structural provisions such that a forklift or overhead crane may be used to lift it into place on the front of the van trailer or semi-trailer.

One embodiment of the aerodynamic forebody device is installed over a conventional refrigeration unit of a refrigerated van trailer or semi-trailer. In this embodiment, sufficient ventilation openings and access openings are provided in the aerodynamic forebody device to allow for operation of the conventional refrigeration unit. In at least one embodiment, one or more access panels are provided to access umbilical connections between the tractor and the van trailer or semi-trailer. In another embodiment, one or more access panels are provided to access the mounting points for the aerodynamic forebody device. In another embodiment, indentations are provided to access the mounting points.

As described above, the Aerodynamic Forebody Shape for Van Trailer and a vehicle made with this device provide a number of advantages, some of which have been described above and others of which are inherent in the invention. Also, modifications may be proposed to the Aerodynamic Forebody Shape for Van Trailer or a vehicle made with this device without departing from the teachings herein.

### BRIEF DESCRIPTION OF THE DRAWINGS

FIG. 1—An embodiment of the present invention, a tractor semi-trailer combination vehicle having an aerodynamic forebody device.

FIG. 2—An embodiment of the present invention, a semi-trailer having an aerodynamic forebody device.

FIG. 3—An embodiment of the present invention, a tractor semi-trailer combination vehicle having an aerodynamic forebody device.

FIG. 4—An embodiment of the present invention, a tractor semi-trailer combination vehicle having an aerodynamic forebody device.

FIG. 5—An embodiment of the present invention, a tractor semi-trailer combination vehicle having an aerodynamic forebody device.

FIG. 6—An embodiment of the present invention, a tractor semi-trailer combination vehicle having an aerodynamic forebody device.

FIG. 7—An embodiment of the present invention, an aerodynamic forebody device.

FIG. 8—An embodiment of the present invention, an aerodynamic forebody device.

FIG. 9—An embodiment of the present invention, an aerodynamic forebody device.

FIG. 10—An embodiment of the present invention, an aerodynamic forebody device.

FIG. 11—An embodiment of the present invention, an aerodynamic forebody device.

FIG. 12—An embodiment of the present invention, a tractor semi-trailer combination vehicle having an aerodynamic forebody device.

FIG. 13—An embodiment of the present invention, a semi-trailer having an aerodynamic forebody device.

FIG. 14—A chart showing a relationship between aerodynamic drag and the inclination angle of the top surface of an embodiment of the invention.

FIG. 15—An embodiment of the present invention, an aerodynamic forebody device.

FIG. 16—An embodiment of the present invention, an aerodynamic forebody device.

FIG. 17—An embodiment of the present invention, an aerodynamic forebody device.

FIG. 18—An embodiment of the present invention, a semi-trailer having an aerodynamic forebody device.

FIG. 19—An embodiment of the present invention, a semi-trailer having an aerodynamic forebody device.

### DETAILED DESCRIPTION OF THE INVENTION

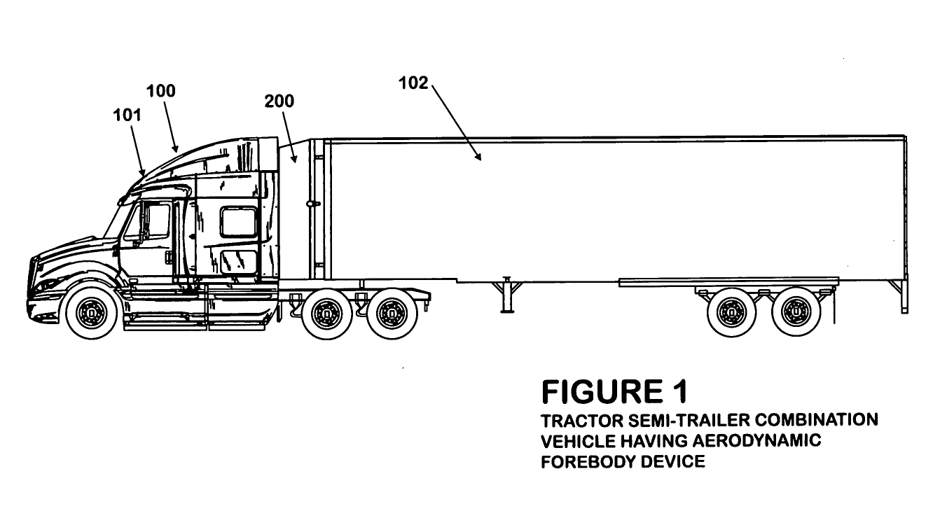

FIG. 1 shows a tractor-trailer combination vehicle 100 having a tractor 101 and a semi-trailer 102. An embodiment of the present invention, an aerodynamic forebody device 200 is shown attached to the front of the semi-trailer 102.

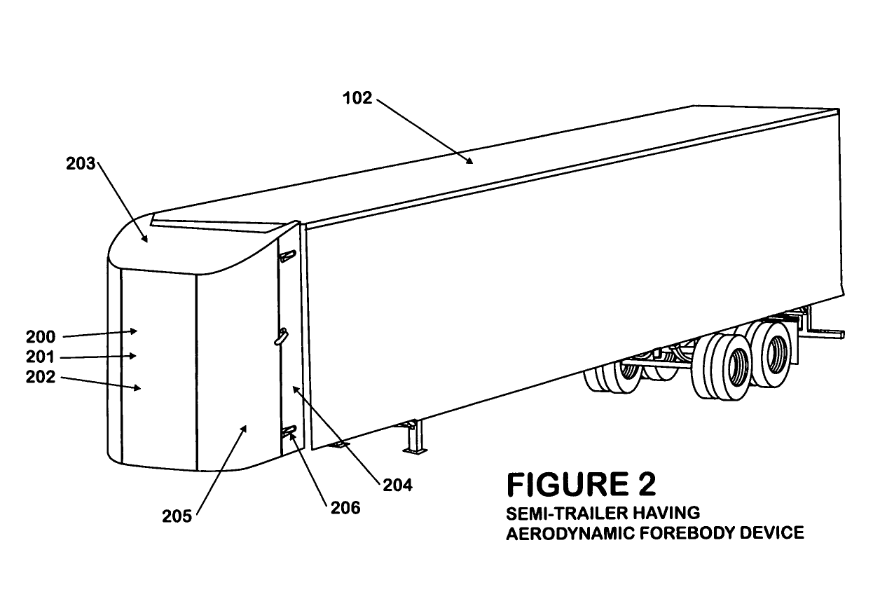

FIG. 2 again shows a semi-trailer 102 with an embodiment of the present invention, an aerodynamic forebody device 200 attached to the front of the semi-trailer 102. The aerodynamic forebody device 200 shown in FIG. 2 has a body 201 having a front face 202, a top face 203, and side faces 204. The corners 205 between the front face 202 and the side faces 204 are rounded in order to allow articulation of the semi-trailer 102 and also to facilitate attachment of laminar air flow to the sides of the semi-trailer 102. The aerodynamic forebody device 200 is provided with mounting features 206 to attach it securely to the front of the semi-trailer 102.

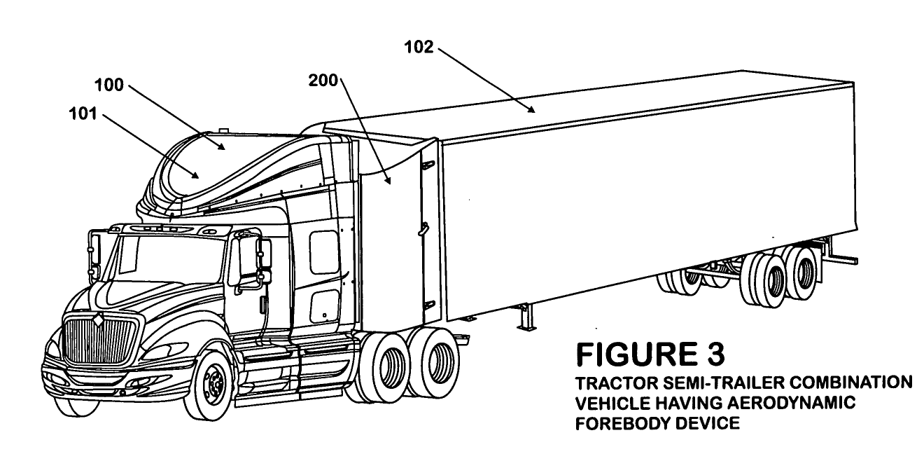

FIG. 3 shows a tractor-trailer combination vehicle 100, similar to the tractor-trailer combination vehicle 100 shown in FIG. 1. The tractor-trailer combination vehicle 100 shown in FIG. 3 again has a tractor 101 and a semi-trailer 102. An embodiment of the present invention, an aerodynamic forebody device 200 is again shown attached to the front of the semi-trailer 102.

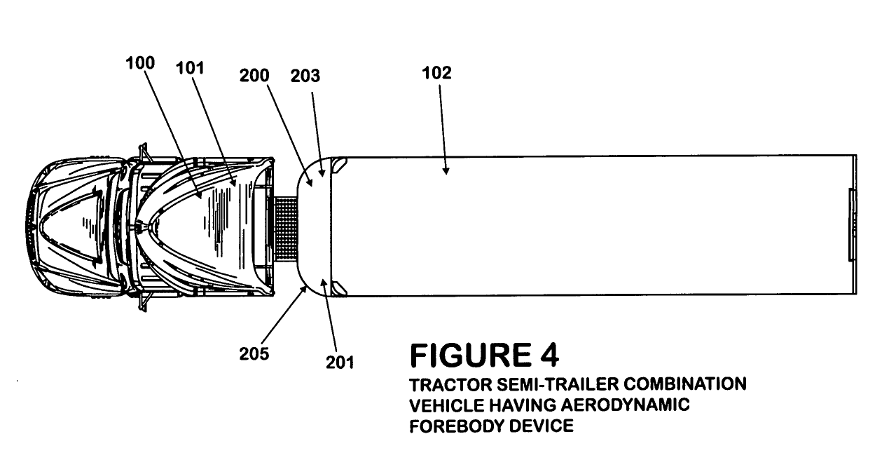

FIG. 4 again shows a tractor-trailer combination vehicle 100, similar to the tractor-trailer combination vehicle 100 shown in FIGS. 1 and 3. The tractor-trailer combination vehicle 100 shown in FIG. 4 again has a tractor 101, a semi-trailer 102, and an embodiment of the present invention, an aerodynamic forebody device 200 attached to the front of the semi-trailer 102. FIG. 4 clearly shows the body 201 of the aerodynamic forebody device 200 having a top face 203 and rounded corners 205.

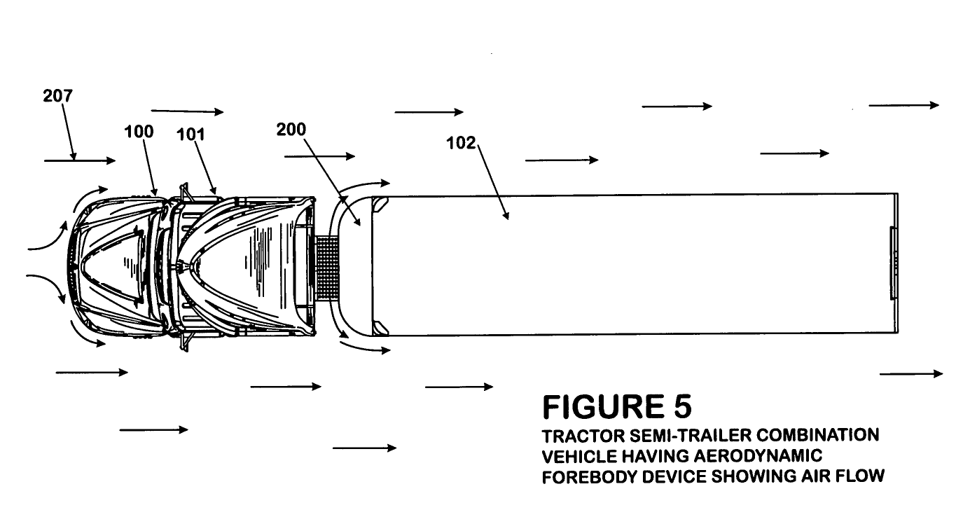

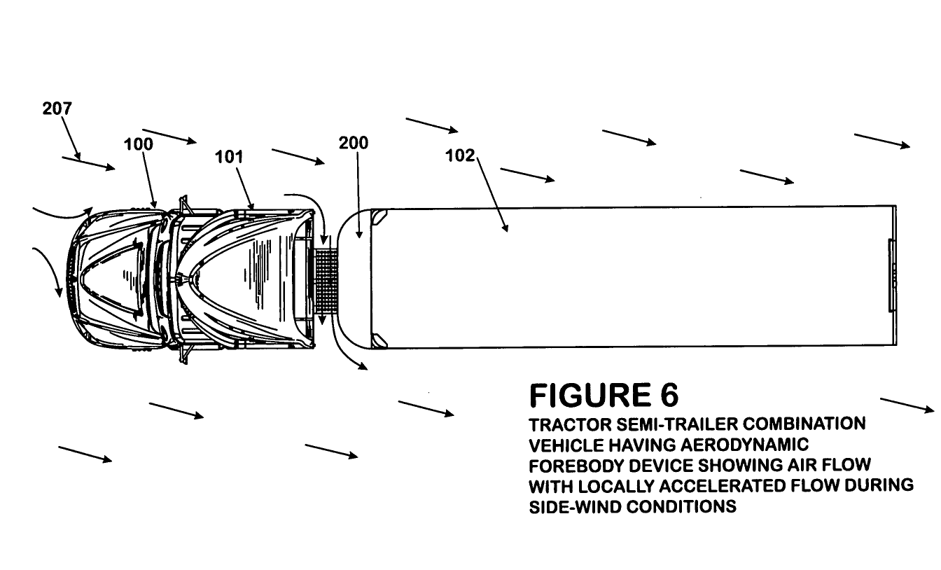

FIGS. 5 and 6 both show a tractor-trailer combination vehicle 100, similar to the tractor-trailer combination vehicle 100 shown in FIGS. 1, 3, and 4. The tractor-trailer combination vehicle 100 shown in FIGS. 5 and 6 again has a tractor 101, a semi-trailer 102, and an embodiment of the present invention, an aerodynamic forebody device 200 attached to the front of the semi-trailer 102. Air flow 207 is shown impinging upon the tractor-trailer combination vehicle 100, coming from directly forward in FIG. 5 and at an angle in FIG. 6. FIGS. 5 and 6 show how the air flow 207 is affected by the aerodynamic forebody device 200 such that it facilitates attachment of laminar air flow to the sides of the semi-trailer 102.

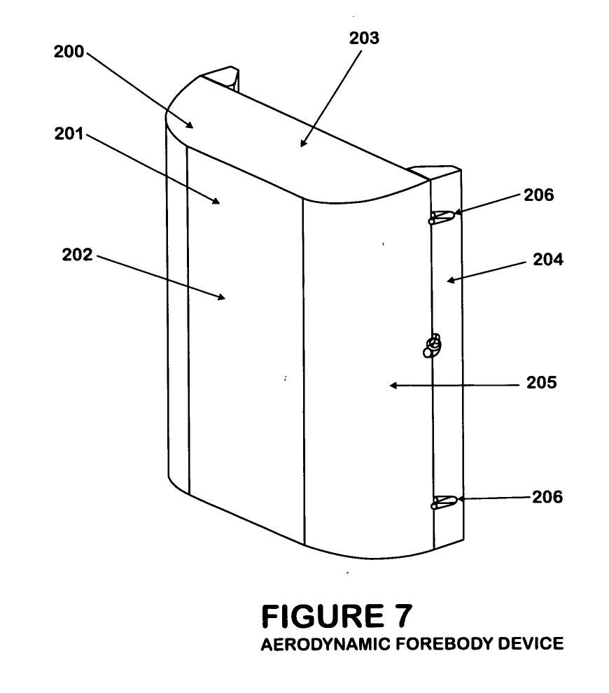

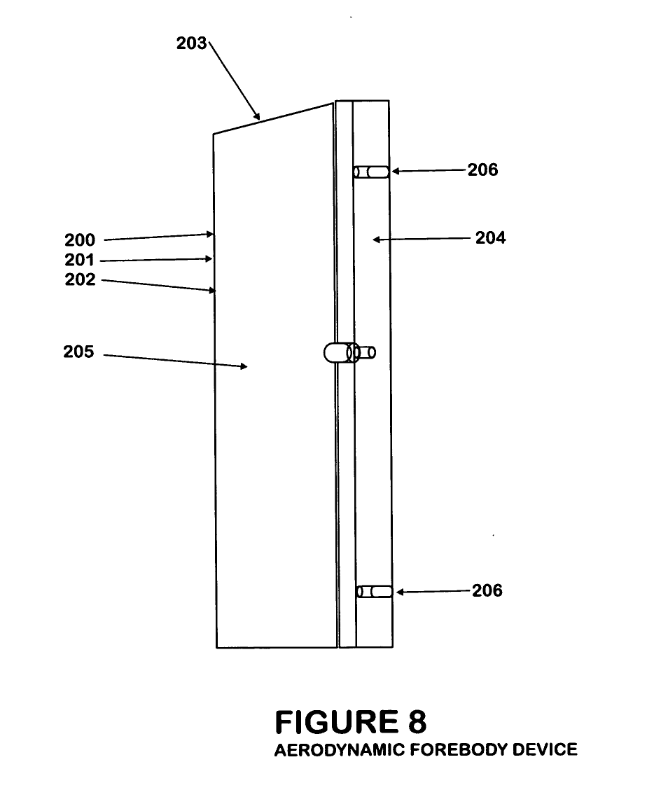

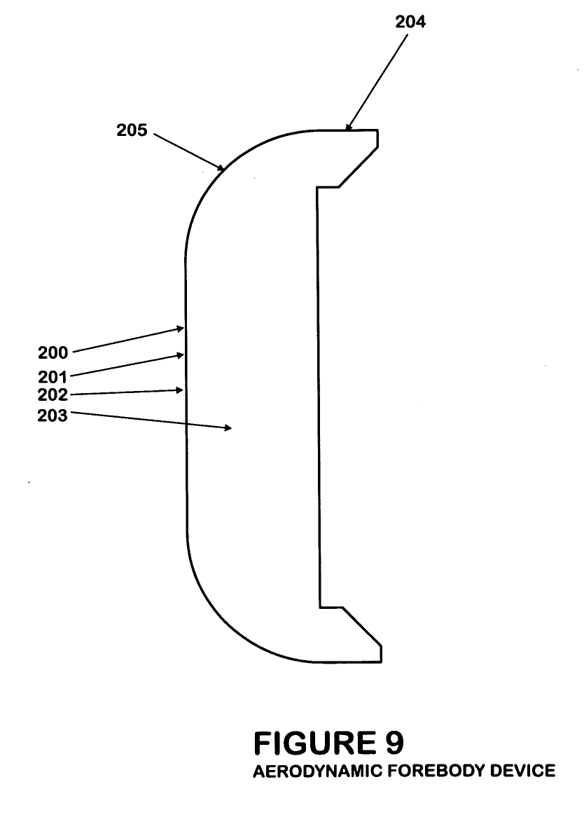

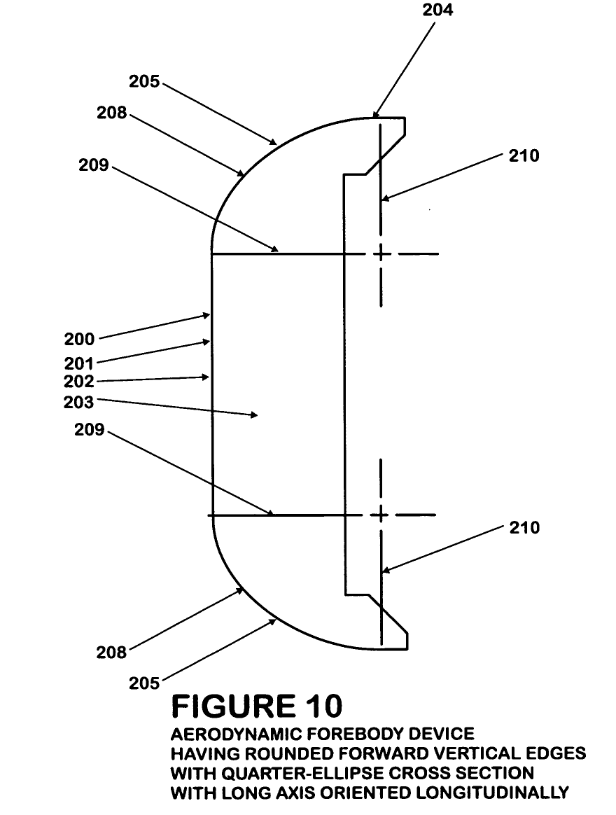

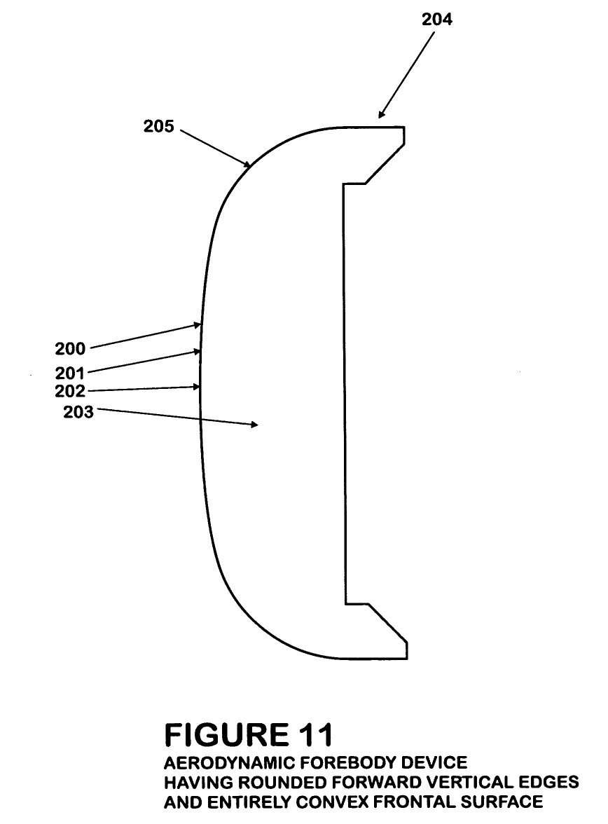

FIGS. 7, 8, 9, 10, and 11 show various views of embodiments of an aerodynamic forebody device 200 having a body 201, a front face 202, a top face 203, and side faces 204. Each aerodynamic forebody device 200 is provided with rounded corners 205 between the front face 202 and the side faces 204, and is also provided with mounting features 206, though the mounting features 206 are not visible in FIGS. 9, 10, and 11. The rounded corners 205 between the front face 202 and the side faces 204 of the embodiment of the aerodynamic forebody device 200 shown in FIG. 10 are defined by a quarter-ellipse cross section 208. Each quarter-ellipse cross section 208 is further defined by a quarter-ellipse long axis 209, which is aligned longitudinally, and a quarter-ellipse short axis 210, which is aligned laterally. The aerodynamic forebody device 200 shown in FIG. 11 is further provided with a convex front face 202.

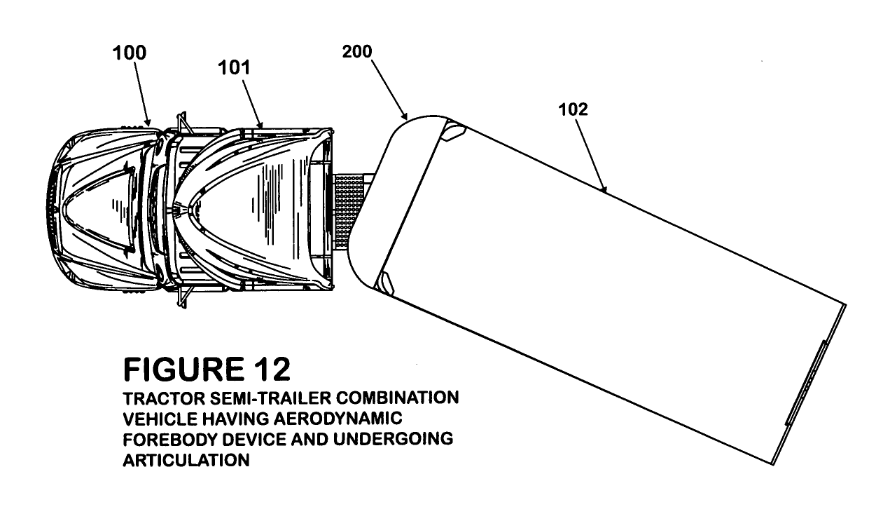

FIG. 12 shows a tractor-trailer combination vehicle 100, similar to the tractor-trailer combination vehicle 100 shown in FIGS. 1, 3, 4, 5, and 6. The tractor-trailer combination vehicle 100 shown in FIG. 12 again has a tractor 101, a semi-trailer 102, and an embodiment of the present invention, an aerodynamic forebody device 200 attached to the front of the semi-trailer 102. The tractor-trailer combination vehicle 100 is shown articulating, thereby showing further advantage to the aerodynamic forebody device 200 having rounded corners.

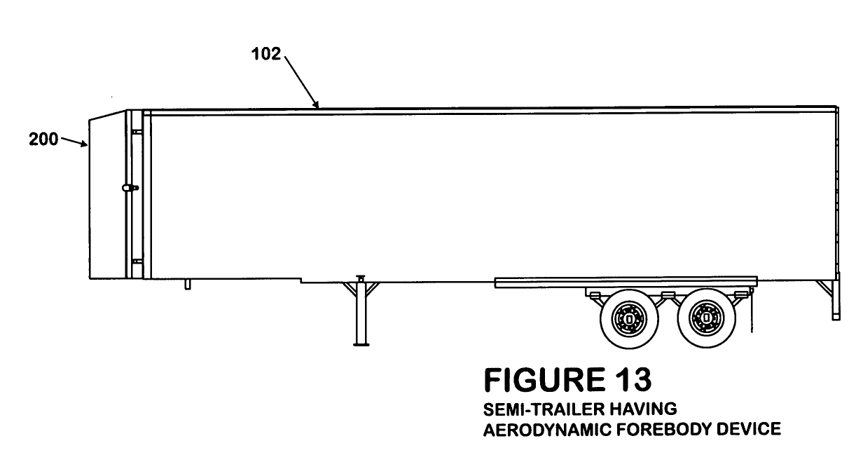

FIG. 13 shows an aerodynamic forebody device 200 attached to the front of a semi-trailer 102.

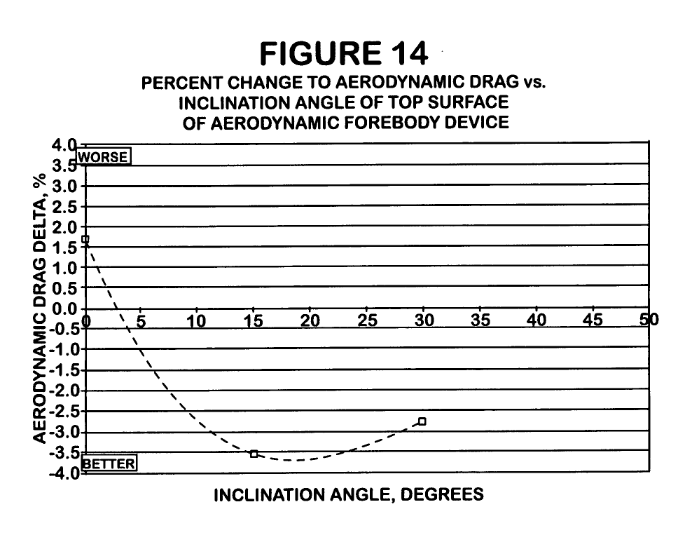

FIG. 14 shows a chart of the relationship between the inclination angle “A” of the top face 203 of the aerodynamic forebody device 200 and the resulting change to the overall aerodynamic drag coefficient of the tractor-trailer combination vehicle 100. Note that the percentage reduction to the overall aerodynamic drag coefficient is maximized between about 15 and 22 degrees inclination angle “A”.

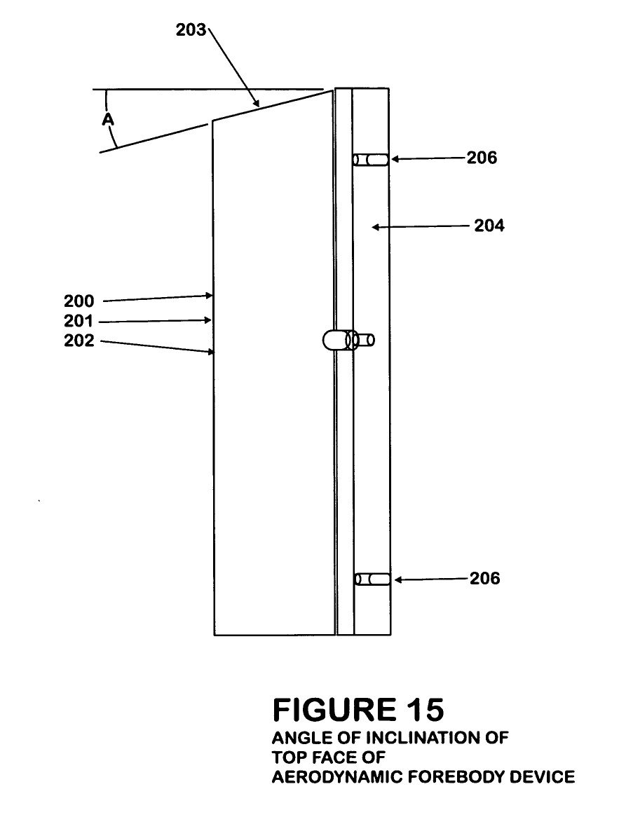

FIG. 15 again shows an embodiment of an aerodynamic forebody device 200 having a body 201, a front face 202, a top face 203, side faces 204 and mounting features 206. The top face 203 is oriented at an inclination angle “A” from horizontal, which angle “A” corresponds to the inclination angle “A” charted in FIG. 14.

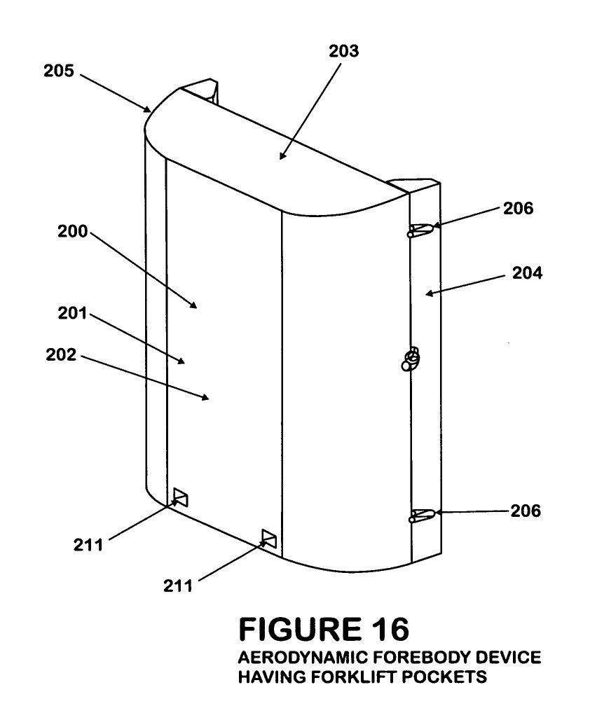

FIG. 16 again shows an embodiment of an aerodynamic forebody device 200 having a body 201, a front face 202, a top face 203, side faces 204, rounded corners 205, and mounting features 206. In addition, the aerodynamic forebody device 200 shown in FIG. 16 is provided with forklift pockets 211.

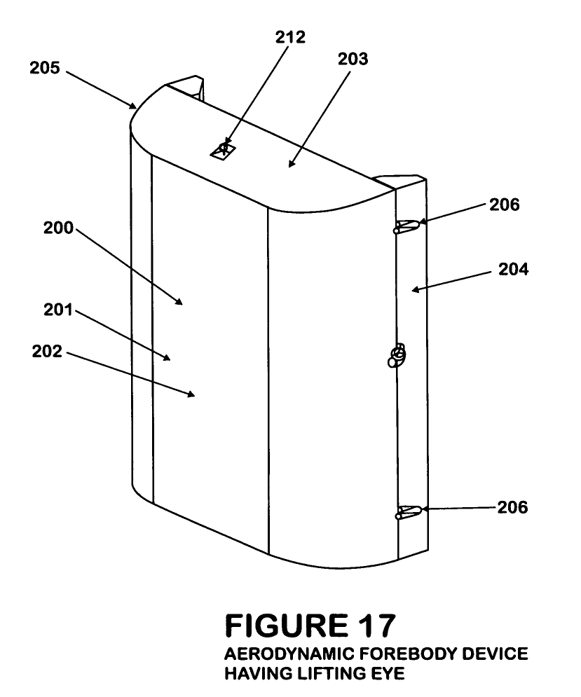

FIG. 17 again shows an embodiment of an aerodynamic forebody device 200 having a body 201, a front face 202, a top face 203, side faces 204, rounded corners 205, and mounting features 206. In addition, the aerodynamic forebody device 200 shown in FIG. 17 is provided with a lifting eye 212.

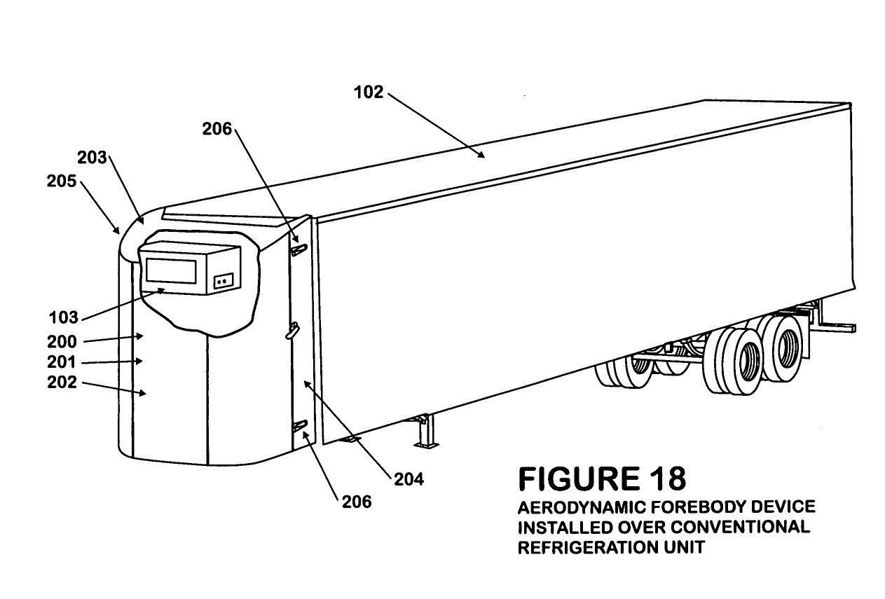

FIG. 18 shows a semi-trailer 102 with an embodiment of the present invention, an aerodynamic forebody device 200 attached to the front of the semi-trailer 102 and covering a refrigeration unit 103. The aerodynamic forebody device 200 shown in FIG. 18 has a body 201, a front face 202, a top face 203, side faces 204, rounded corners 205, and mounting features 206.

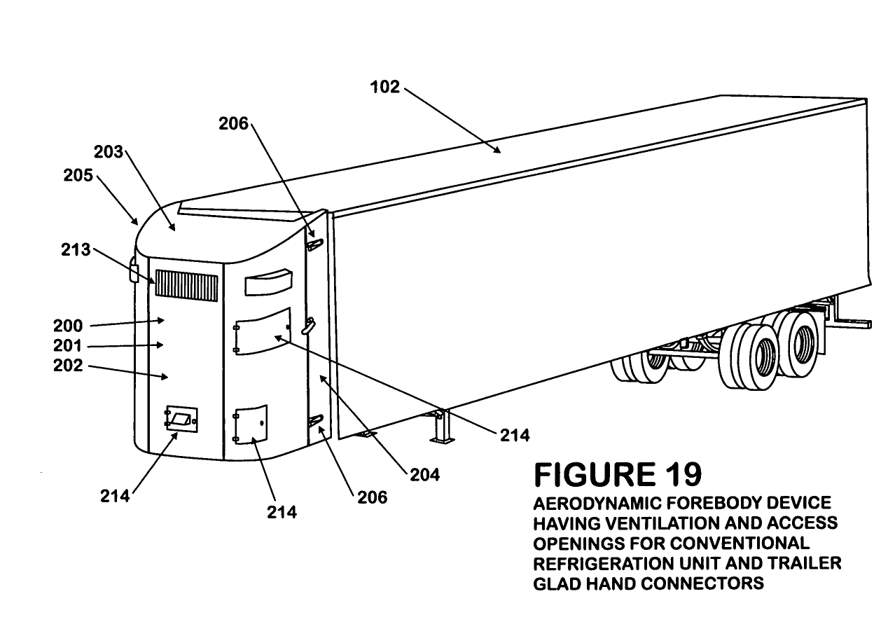

FIG. 19 again shows a semi-trailer 102 with an embodiment of the present invention, an aerodynamic forebody device 200 attached to the front of the semi-trailer 102 and covering a refrigeration unit 103 (not visible). The aerodynamic forebody device 200 shown in FIG. 19 again has a body 201, a front face 202, a top face 203, side faces 204, rounded corners 205, and mounting features 206. In addition, the aerodynamic forebody device 200 shown in FIG. 19 has ventilation openings 213 and access openings 214, in order to provide cooling air to the refrigeration unit 103 (not visible) and access to points on the front of the semi-trailer 102.

While specific embodiments have been described in detail in the foregoing detailed description and illustrated in the accompanying drawings, those with ordinary skill in the art will appreciate that various permutations of the invention are possible without departing from the teachings disclosed herein. Accordingly, the particular arrangements disclosed are meant to be illustrative only and not limiting as to the scope of the invention, which is to be given the full breadth of the appended claims and any and all equivalents thereof. Other advantages to a tractor-trailer combination vehicle equipped with an Aerodynamic Forebody Device may also be inherent in the invention, without having been described above.

I claim:

1. An aerodynamic forebody device for use with a semi-trailer of a tractor-trailer combination vehicle, comprising:
a body having the form of a rectangular parallelepiped, said rectangular parallelepiped having a top face, a front face, and side faces;
said top face being at a downward inclination angle toward said front face;
each of said side faces intersecting said front face; and
said intersections of said side faces and said front face being rounded.

2. The aerodynamic forebody device for use with a semi-trailer of a tractor-trailer combination vehicle of claim 1, wherein:
said inclination angle of said top face is between about 5 and about 30 degrees from horizontal.

3. The aerodynamic forebody device for use with a semi-trailer of a tractor-trailer combination vehicle of claim 2, wherein:
said inclination angle of said top face is between about 15 and about 22 degrees from horizontal.

4. The aerodynamic forebody device for use with a semi-trailer of a tractor-trailer combination vehicle of claim 1, wherein:
said intersections of said side faces and said front face each has a cross-section that describes a quarter-ellipse.

5. The aerodynamic forebody device for use with a semi-trailer of a tractor-trailer combination vehicle of claim 4, wherein:
said quarter ellipse having a long axis and a short axis;
said long axis of said quarter-ellipse being oriented in a longitudinal direction, perpendicular to said front face; and
said short axis of said quarter-ellipse being oriented in a lateral direction, perpendicular to said side faces.

6. The aerodynamic forebody device for use with a semi-trailer of a tractor-trailer combination vehicle of claim 1, wherein:
said front face is flat.

7. The aerodynamic forebody device for use with a semi-trailer of a tractor-trailer combination vehicle of claim 1, wherein:
said front face is convex.

8. The aerodynamic forebody device for use with a semi-trailer of a tractor-trailer combination vehicle of claim 1, wherein:
said top face is flat.

9. The aerodynamic forebody device for use with a semi-trailer of a tractor-trailer combination vehicle of claim 1, wherein:
said top face is convex.

10. The aerodynamic forebody device for use with a semi-trailer of a tractor-trailer combination vehicle of claim 1, wherein:
said body is supported by a reinforcing frame.

11. The aerodynamic forebody device for use with a semi-trailer of a tractor-trailer combination vehicle of claim 1, wherein:
said semi-trailer is provided with at least one mounting bracket;
said body is provided with at least one mating bracket; and
said at least one mating bracket being compatible with said at least one mounting bracket, such that said body may be hung upon said semi-trailer prior to affixing said body securely to said semi-trailer.

12. The aerodynamic forebody device for use with a semi-trailer of a tractor-trailer combination vehicle of claim 1, wherein:
said body having forklift pockets.

13. The aerodynamic forebody device for use with a semi-trailer of a tractor-trailer combination vehicle of claim 1, wherein:
said body having at least one lifting eye.

14. The aerodynamic forebody device for use with a semi-trailer of a tractor-trailer combination vehicle of claim 1, wherein:
said semi-trailer being provided with a refrigeration unit;
said body being installed over said refrigeration unit.

15. The aerodynamic forebody device for use with a semi-trailer of a tractor-trailer combination vehicle of claim 14, wherein:
said body having at least one opening.

16. A vehicle for operation on the ground, comprising:
a tractor;
a semi-trailer having a front face;
an aerodynamic forebody device attached to said front face of said semi-trailer;
said aerodynamic forebody device having a body having the form of a rectangular parallelepiped, said rectangular parallelepiped having a top face, a front face, and side faces;
said top face being at a downward inclination angle toward said front face;
each of said side faces intersecting said front face; and
said intersections of said side faces and said front face being rounded.

17. The vehicle for operation on the ground of claim 16, wherein:
said inclination angle of said top face is between about 5 and about 30 degrees from horizontal.

18. The vehicle for operation on the ground of claim 17, wherein:
said inclination angle of said top face is between about 15 and about 22 degrees from horizontal.

19. The vehicle for operation on the ground of claim 16, wherein:
said intersections of said side faces and said front face each has a cross-section that describes a quarter-ellipse.

20. The vehicle for operation on the ground of claim 19, wherein:
said quarter ellipse having a long axis and a short axis;
said long axis of said quarter-ellipse being oriented in a longitudinal direction, perpendicular to said front face; and
said short axis of said quarter-ellipse being oriented in a lateral direction, perpendicular to said side faces.
